(19) United States
(12) Patent Application Publication
(10) Pub. No.: US 2007/0218304 A1
(43) Pub. Date: Sep. 20, 2007

(54) Active oxygen barrier compositions of poly(hydroxyalkanoates) and articles made thereof

(75) Inventors: Philip D. Bourgeois, Red Lion, PA (US); Sami Al-AbdulRazzak, Mississauga (CA)

Correspondence Address: RISSMAN JOBSE HENDRICKS & OLIVERIO, LLP, ONE STATE STREET, SUITE 800, BOSTON, MA, 02109, US

(73) Assignee: Graham Packaging Company, LP, York, PA (US)

(21) Appl. No.: 11/384,897

(22) Filed: Mar. 20, 2006

(51) Int. Cl. B32B 27/36; B32B 27/18; C01B 3/00

(52) U.S. Cl. 428/480; 252/188.28; 524/435

(57) ABSTRACT

Active oxygen barrier compositions and articles made therefrom based on poly(hydroxyalkanoate), preferably poly(lactic acid), a polymer derived from lactic acid, also known as 2-hydroxy propionic acid, and a transition metal. This active barrier composition, which has been found to consume (scavenge) oxygen, can be utilized in monolithic and multilayer packaging articles, such as preforms and containers, for regulating the exposure of oxygen-sensitive products to oxygen and thus maintaining and enhancing the quality and shelf-life of the product. When provided in multilayer structures with adjacent poly(hydroxyalkanoate) layers, the package both consumes oxygen and provides a biodegradable package and/or one that may be included in a recycling stream.

### FIELD OF THE INVENTION

The invention generally relates to compositions, articles and methods for intercepting and scavenging oxygen in environments containing oxygen-sensitive products, such as food and beverages.

### BACKGROUND OF THE INVENTION

Plastic packaging that provides a means of intercepting and scavenging oxygen as it passes through the walls of the package (herein referred to as an “active oxygen barrier”), can enhance the quality and shelf-life of many products. Such active barrier packaging can be more effective than a “passive barrier” which merely retards oxygen permeation into the package. In contrast, the active barrier can remove oxygen initially present and/or generated in the interior of the package, as well as retard the passage of exterior oxygen into the package.

The requirements for a commercially successful active barrier package will vary by application, but typically include one or more of the following:
a) ability to process one or more polymer materials on commercial molding (e.g., injection, compression, extrusion, blow molding) equipment;
b) ability to provide a multilayer structure with sufficient layer integrity and adherence during processing and in use;
c) cost effective use of (typically) more expensive barrier materials, i.e., generally in a multilayer structure;
d) avoiding the generation and/or transmission of adverse reaction byproducts which may affect the taste and smell of the packaged material or raise government regulatory issues;
e) provide transparency, whereby at least 50% transmission of visible light is preferred; and/or
f) enable effective use of the packaging material in a recycling stream and/or as biodegradable waste.

Thus, there is an ongoing need for compositions and articles which can satisfy the processing, aesthetic and mechanical properties (e.g., top load strength) required of various commercial packaging applications, while also regulating the exposure to oxygen of products contained in such packages in order to maintain and enhance the quality and shelf-life of the product.

### SUMMARY OF THE INVENTION

The following aspects of the invention may be used independently and/or in various combinations to provide an active oxygen barrier composition, article and/or method.

In one aspect, an active oxygen barrier composition is provided comprising a poly(hydroxyalkanoate) (“PHA”) having the formula H—[O—CHR—(CH₂)ₓ—CO]ₙ—OH, and a transition metal, where R is H (hydrogen) or an organic radical having up to about 13 carbon atoms (preferably a hydrocarbon radical), x is from 0 to 3, and n is from 10 to 20,000 (hereinafter referred to as the “active oxygen barrier composition”). Typically, “n” is selected such that the PHA polymer has a molecular weight ranging from about 700 to about 1,440,000 daltons. In a preferred embodiment, the PHA includes or substantially comprises poly(lactic acid) (“PLA”), a polymer derived from lactic acid, also known as 2-hydroxy propionic acid. In various embodiments, the transition metal is provided as a metal compound, with for example an organic ligand, and the metal of the transition metal compound is generally present in an amount of at least about 20 ppm in the PHA. The transition metal may be cobalt, and more particularly the metal compound may be cobalt neodecanoate. The metal compound may comprise from about 0.01 to about 3 percent by weight of the composition; the amount is varied based on the application (e.g., monolayer or multilayer structure, wall thickness, product, desired shelf-life, etc.). The transition metal can be one that is selected from the group consisting of iron, cobalt, nickel, ruthenium, rhodium, palladium, osmium, iridium, platinum, copper, manganese and zinc.

An article of manufacture may be made from such an active oxygen barrier composition, comprising e.g., at least a portion of a package, preform, container, film, sheet, liner, coating or closure. The article may be either monolithic or multilayer. In various embodiments, the active barrier composition is provided as one or more layers of a multilayer beverage container. In another embodiment, a monolithic beverage bottle (e.g., for water) is provided.

In one embodiment, the multilayer article includes at least one layer of the active oxygen barrier composition, and at least one adjacent layer of PHA, wherein the PHA of the active barrier composition and/or the at least one adjacent layer is preferably poly(lactic acid). The adjacent layer of PLA may be provided between an oxygen-sensitive product and the active barrier composition in order to allow migration of oxygen molecules, for example from the interior of the package, to reach the layer of the active oxygen barrier composition, thereby enabling consumption of oxygen initially present and/or generated in the product during use.

In one particular embodiment of the invention, a multilayer preform or container is provided for the packaging of an oxygen-sensitive food or beverage. The article includes one or more alternating layers of the active oxygen barrier composition, and one or more layers of PHA, one or both of which include or substantially comprise poly(lactic acid). Most preferably the active oxygen barrier composition is contained within a layer that is arranged/disposed in the sequence of layers such that this layer does not make direct contact with the food or beverage in the final container product.

In one embodiment, an active oxygen barrier composition is provided comprising poly(lactic) acid and a transition metal.

In another embodiment, an active oxygen barrier composition is provided comprising a poly(hydroxyalkanoate) polymer of the formula H—[O—CHR—(CH₂)ₓ—CO]ₙ—OH and a transition metal, where R is hydrogen or an organic radical having up to about 13 carbon atoms, x is from 0 to 3, and n is from about 10 to about 20,000.

In another embodiment, a method is provided of making a multilayer article for holding an oxygen sensitive product, the method including molding an intermediate article having a first layer comprised of a poly(hydroxyalkanoate) polymer and a second layer adjacent to the first layer comprised of a poly(hydroxyalkanoate) polymer and a transition metal, and expanding the intermediate article to form the multilayer article.

In another embodiment, a method is provided of imparting oxygen scavenging activity to a packaging article that is comprised of multiple layers of poly(hydroxyalkanoate) polymer, the method comprising mixing a transition metal into at least one of the multiple layers of the article.

In another embodiment, a method is provided of imparting oxygen scavenging activity to a poly(hydroxyalkanoate) polymer composition comprising mixing a transition metal with a poly(hydroxyalkanoate) polymer.

These and other features of the present invention will be more particularly understood with regard to the following detailed description and drawings.

### BRIEF DESCRIPTION OF THE FIGURES

The invention may be further understood with reference to the drawings wherein:

FIG. 1 is a side elevational view of a multilayer preform incorporating two layers of an active oxygen barrier composition, according to one embodiment of the invention;

FIG. 2 is a side elevational view of a multilayer container having a transparent multilayer sidewall, made from the preform of FIG. 1;

FIG. 3 is a horizontal cross section taken along line 3-3 of FIG. 2, showing the multilayer sidewall of the container;

FIG. 4 is a vertical cross section of a blow molding apparatus for making the container (of FIG. 2) from the preform (of FIG. 1);

FIG. 5 is a graph of % Oxygen in a closed container vs. Time (in days) comparing the amount of oxygen reduction achieved by a series of PLA plaques made from compositions of the present invention of varying cobalt concentration;

FIG. 6 is a graph of % Oxygen in a closed container vs. Time (in days) comparing the amount of oxygen reduction achieved by a series of PLA plaques made from compositions of the present invention of varying cobalt concentration;

FIG. 7 is a graph of % Oxygen in a closed container vs. Time (in days) comparing the oxygen reduction achieved by a series of PLA plaques made from compositions of the present invention of varying cobalt concentration.

### DETAILED DESCRIPTION

It has been found that an active oxygen barrier composition can be formed from a combination of PHA and a transition metal. This composition can be used with and in a variety of articles for the packaging of oxygen-sensitive products. These articles include all or a portion of a molded article, such as a package, preform or container, a closure (e.g., cap, lid or the like) for the package, an insert (e.g., liner, gasket or the like) for the package or closure, a sachet (e.g., for placement in the cavity or interior of the package), a coating, an absorbed layer on a variety of supports, etc.

Poly(Lactic Acid)

Poly(lactic acid) (“PLA”) as used herein refers to a polymer having more than 50% by weight lactic acid units, i.e., a repeating chain of lactic acid. The material can be either the right-handed (D) or left-handed (L) enantiomer of an optical isomer, or can be a racemic mixture of the two enantiomers. It is preferably unplasticized, but can also be used in a plasticized state with residual monomer, oligomer, etc.

One example of a suitable PLA polymer is bottle grade PLA resin available from NatureWorks, 15305 Minnetonka Blvd., Minnetonka, Minn. 55345. For example, NatureWorks PLA 7000D is suitable for injection stretch blow molding (ISBM) applications, using conventional ISBM equipment. Its physical properties include for example a specific gravity of 1.25-1.28 (based on ASTM method D792), a melt density at 230° C. of 1.08-1.12 g/cc (ASTM method D1238), a glass transition temperature of 130-140° F. (55-60° C.) (ASTM method D3417), a crystalline melt temperature (Tₘ) of 295-310° F. (145-155° C.) (as measured by ASTM method D3418), and a melt volume flow rate (MFR) at 210° C. of 5-15 g/10 min. (ASTM method D1238A and B). The polymer can be stretch blow molded at a preform temperature of 80-100° C., a stretch rod speed of 1.2 to 2 meters per second, and a blow mold temperature of 70-100° F. (21-38° C.).

PLA is a hygroscopic thermoplastic that readily absorbs moisture from the atmosphere. Thus, PLA is typically thoroughly dried, e.g., to less than 250 parts per million (ppm) moisture, before melt processing to avoid a drop in molecular weight during melt processing (and the resulting reduction in mechanical properties). Virgin PLA is provided by NatureWorks as crystalline pellets (25% crystallinity), for ease of drying.

The molecular weight of the PHA or PLA polymer will affect the physical properties of an article made from such polymer. For example, NatureWorks 7000D bottle grade PLA resin has a relative viscosity (RV) of 3.9 to 4.1.

Depending upon the particular application, a preform made from the active oxygen barrier composition of the present invention may be designed with a planar or area (axial times hoop) stretch ratio (SR) of 8 to 11, an axial SR of 2 to 3, and hoop SR of 3 to 4. These are given by way of example only; the specific application will determine the actual preform design and stretch ratio.

In comparison to polyethylene terepthalate (PET), a polyester polymer widely used in the bottle industry, PHA, and in particular, PLA, exhibits a higher transport rate for water vapor, carbon dioxide and oxygen, i.e., by a factor of about 8-10 times that of PET. For example, PLA may have a water vapor transmission rate of 20 (units of cc-mil/100 in 2-day-atm) at 20° C. and 0% relative humidity (RH); an O₂ transmission rate of 40 (same units), and a CO₂ transmission rate of 172 (same units). The ability to substantially lower the oxygen transmission rate of PLA in accordance with the present invention is thus particularly beneficial as it enables use of PLA in current applications utilizing PET.

In addition, PLA is a biodegradable polymer, in contrast to many of the commercially important polymers now used in packaging. PLA polymer 7000D has been shown to biodegrade similar to paper under simulated composting conditions (ASTM D5338 at 58° C. (135° F.)) and satisfies proposed European composting certification standards. Composting is a method of waste disposal that allows organic materials to be recycled into a product that can be used as a valuable soil additive. PLA is made primarily of poly(lactic acid), a repeating chain of lactic acid, which undergoes a two-step degradation process. First, the moisture and heat in a compost pile will attack the PLA polymer chains and split them apart, creating smaller polymers, and finally lactic acid. Microorganisms in compost soil consume smaller polymer fragments and lactic acid as nutrients. Since lactic acid is widely found in nature, a large number of organisms metabolize lactic acid. The end result of the process is carbon dioxide, water and also humus, a soil nutrient. See NatureWorks publication literature for NatureWorks PLA polymer 7000D (NWPKG0370205Y2).

The Transition Metal

The transition metal can be added to the PHA in the form of the metal itself, as a salt, or as a metal compound. In a preferred embodiment, the active oxygen barrier composition comprises PLA and a transition metal, where the metal is added as a metal compound. Metal compounds typically comprise two components: a metal and a ligand which bonds to the metal, and generally a substantial portion of the ligand is organic.

The metal can be added to the polymer as a liquid, a solution mixture, in crystalline form, as a pastille, or as a powder, depending upon factors such as processing conditions. Typically, the metal is mixed with the polymer to create a physical blend. The active oxygen barrier composition, however, can eventually comprise a chemical bond between the metal and the PHA or the ligand of the metal compound and the PHA, where a chemical reaction occurs in the physical blend of the metal compound and the PHA. In other words, once the metal compound is processed with the PHA, the metal compound can be present in the PHA polymer as the same initial metal compound, a new metal compound, a salt or a metal atom. A new metal compound can occur where at least a portion of the ligand no longer forms a chemical bond with the metal, and a new ligand bonds to the metal. The new ligand can be the PHA polymer, or any other component such as water, or another organic component. Preferably, the initial metal compound is available in a stable form, i.e., the metal compound is unreactive towards oxygen before addition of the compound to the PHA.

The amount of metal present in the polymer is defined relative to the amount by weight in the polymer/metal composition. It is understood that the desired metal concentration can depend on a variety of factors or a combination of factors such as the molecular weight of the metal, the molecular weight of the metal compound, and the polymer type or molecular weight of the PHA. In various embodiments, the metal atom (e.g., cobalt) is present in the polymer/metal composition in an amount of at least about 20 ppm based on the composition, more preferably from about 50 ppm to about 6,000 ppm, even more preferably from about 100 ppm to about 5,000 ppm, and still more preferably from about 200 ppm to about 3,000 ppm. The lower limit of the metal concentration may be determined by a desired level of oxygen-scavenging performance (i.e., insufficient concentrations of metal may not achieve a desired scavenging performance for a given application) and/or processability. The upper limit may be determined by factors such as cost, transparency, color, and/or processability depending on the particular application.

The transition metal can be selected from the group consisting of iron, cobalt, nickel, ruthenium, rhodium, palladium, osmium, iridium, platinum, copper, manganese and zinc. In a preferred embodiment, the metal is cobalt, and more preferably is added as a cobalt carboxylate compound, such as cobalt neodecanoate.

Articles of Manufacture (e.g., Package), Storage and Shelf-Life

Preferably, the active oxygen barrier composition is provided in an article that, once formed, can be stored in the presence of an excess of oxygen, such as air, for a significant period of time (e.g., 2 months, preferably 4 months) without substantial loss of scavenging performance when thereafter filled with a product. Preferably, the article is a package capable of being stored under ambient conditions, where ambient conditions is referred to as an atmosphere of 21% oxygen (air) and a relative humidity of 50% at 23° C.

Also, it is preferable to provide an article (which includes the active oxygen barrier composition) wherein oxygen scavenging will commence upon filling with the product and/or within a short time thereafter (e.g., within 5 days, preferably 2 days, and more preferably within 24 hours of filling).

Layer Compatibility

According to another feature of the invention, the active oxygen barrier composition can be provided in one or more layers of a multilayer article, having the desired layer integrity and layer adherence for a given application. Layer adherence and integrity is generally a function of the processability of the material, which for polymers, is typically a function of the melt viscosity.

A conventional parameter for processability is melt viscosity, as indicated by a melt index. “Melt index” is generally defined as a number of grams of polymer that can be forced through an orifice of a standard unit at a specified temperature and pressure over a defined period of time. The melt index can be measured according to ASTM method D1238-94A. The polymers as used herein, i.e., the active oxygen barrier composition and the other structural and/or barrier polymers utilized in an article, are generally high molecular weight polymers, having a molecular weight of at least about 20,000 daltons for which the melt viscosity is an important process parameter. Generally, as the molecular weight of the polymer increases, both the melt viscosity and melt strength increase. For multilayer applications, those skilled in the art can determine an appropriate combination of melt viscosity and melt strength for a layer of the active oxygen barrier composition positioned adjacent layers of other polymer types.

Where structural layers are positioned adjacent a layer of the active oxygen barrier composition in the absence of an adhesive, it is preferred that the two layers be “compatible.” Compatibility implies that the multilayer article, having at least two layers positioned adjacent each other, have the structural integrity to withstand delamination, observable deformation from a desired shape, or other degradation of a layer caused by a chemical or other process initiated by an adjacent layer during the article-forming process and in the final product during expected use. Compatibility can be enhanced by selecting melt viscosities, melt indices, and solubility parameters that allow one of ordinary skill in the art to achieve a desired package characteristic. If a recyclable bottle is desired, then it may be desired that the layers readily separate when the bottle is cut to enable separate processing of the different materials.

The melt index of the active oxygen barrier composition should take into account a decrease in melt index that can occur for example when a metal (e.g., cobalt) is added to a polymer.

Transparency

One advantage according to another aspect of the invention is the ability to provide an article including the active oxygen barrier composition which is substantially transparent. By substantially transparent it is meant that at least a portion of the package allows the transmission of at least 50% of visible light. More preferably, transparency can be determined by the percent haze for transmitted light through the wall of the article, which is given by the formula:
H_{T}=[Y_{d}+(Y_{d}+Y_{S})]×100
where H_{T} is the percent haze for transmitted light through the wall,
Y_{d} is the diffuse light transmitted by the thickness of the specimen, and
Y_{S} is the specular light transmitted by the thickness of the specimen. The diffuse and specular light transmission values are measured in accordance with ASTM method D-1003, using any standard color difference meter such as Model D25D3P manufactured by HunterLab, Inc., Reston, Va., USA. In select embodiments, the relevant portion of the package, e.g., sidewall, has a percent haze of no greater than 30%, more preferably no greater than 20%, and still more preferably no greater than 10%.

### EXAMPLE

### Oxygen-Scavenging Juice Bottle

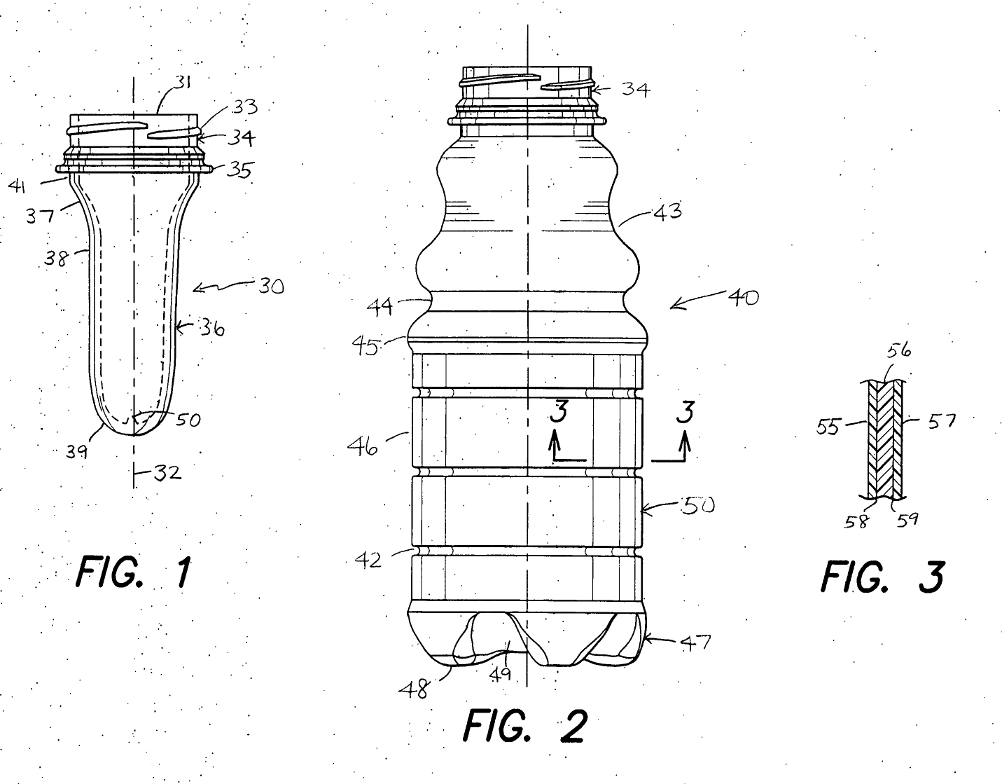

FIGS. 1-4 illustrate a transparent 2-material 5-layer (2M, 5L) preform and container made therefrom, which includes two layers of the active oxygen barrier composition according to the present invention. This multilayer structure enables use of a relatively low weight percentage of the active oxygen barrier composition, e.g., about 3% of the total container weight, while providing a desired level of oxygen scavenging.

An injection molded multilayer preform 30 is shown in FIG. 1. The substantially cylindrical (as defined by vertical centerline 32) preform includes an upper neck portion or finish 34 having a top sealing surface 31 which defines an open top end of the preform, a cylindrical outer surface with threads 33 and a lower flange 35. Below the flange is a body-forming portion 36 most of which will be expanded in forming the body of the container 40. The body-forming portion 36 of the preform includes an upper cylindrical portion 41, an inwardly tapered shoulder-forming portion 37 (decreasing in outer diameter from top to bottom), a cylindrical panel-forming section 38, and substantially hemispherical base-forming section 39 with an interior centering nub 50.

The preform 30 is adapted for making a 16-ounce container 40 (see FIG. 2) for a cold-filled, non-carbonated liquid drink, such as juice. The panel-forming section 38 will undergo an average planar stretch ratio of about 10, where planar stretch ratio is the ratio of the average thickness of the preform panel-forming section 38 to the average thickness of the container panel 46 (as shown in FIG. 2), taken along the length of the respective preform and container portions. The average panel hoop stretch is preferably about 3 to 4 and the average panel axial stretch is about 2 to 3. This produces a container panel 46 with a desired biaxial orientation and visual transparency. The specific panel thickness and stretch ratio selected will depend on the dimensions of the bottle, the internal pressure, and the processing characteristics (as determined by for example by the melt viscosity of the particular materials employed).

Both preform 30 and the resulting container 40 have the two-material five-layer (2M, 5L) structure shown in FIG. 3. The multiple layers comprise, in serial order, an outermost layer of PLA 57, an outer intermediate layer of the active oxygen barrier composition 59, a central core layer of PLA 56, an inner intermediate layer of the active oxygen barrier composition 58, and an innermost layer of PLA 55. The outermost, core and innermost PLA layers may be of any commercially available PLA having a melt index of about 5-15 g/10 min. at 210° C. (ASTM D1238 A, B). The two intermediate layers of the PLA active oxygen barrier composition of the present invention may have a melt index of about 5-15 g/10 min, a T_{g} of about 55° C., and a melting point of about 145° C. The active oxygen barrier composition includes 20-6,000 micrograms of cobalt per gram of polymer (i.e., 20-6,000 ppm cobalt per weight of PLA); the cobalt is added as cobalt neodecanoate. The weight ratio of outermost, innermost and core layers, to the intermediate layers, is preferably in a range of about 99:1 and 80:20.

The preform shown in FIG. 1 may be injection molded by any of various known processes, including sequential, simultaneous and any combination thereof, including for example the sequential metered process described in U.S. Pat. Nos. 4,550,043, 4,781,954, 5,049,345 and 5,582,788, owned by Graham PET Technologies Inc. (formerly Continental PET Technologies, Inc.), and hereby incorporated by reference in their entirety. In this process, predetermined amounts of the materials are introduced into the gate of the preform mold as follows: a first shot of PLA which forms partially-solidified innermost and outermost preform layers as it moves up the cool outer mold and core walls; a second shot of the active oxygen barrier composition which will form the inner and outer intermediate layers; and a third shot of the PLA which pushes the active barrier composition up the sidewall (to form thin intermediate layers) while the third shot forms a central core layer. After the mold is filled, the pressure is increased to pack the mold against shrinkage of the preform. After packing, the mold pressure is partially reduced and held while the preform cools.

FIG. 2 shows a 16 ounce cold-filled noncarbonated juice bottle 40 made from the preform of FIG. 1. The bottle 40 includes a transparent biaxially-oriented container body 50. The upper thread finish 34 has not been expanded (same as that of preform 30), but is of sufficient thickness or material construction to provide the required strength for application of a closure (e.g., screw-on cap). The expanded container body 50 includes an upper shoulder section 43, an indented annular rib 44, a dome portion 45 and a cylindrical panel section 46 with a plurality of annular ribs 42. The panel section 46 preferably has been stretched at an average planar stretch ratio of 10. The body also includes a footed base 47 having a plurality of feet 48 separated by ribs 49.

FIG. 3 is an expanded cross-sectional view of the 5-layer container panel wall 46. The wall 46 comprises three relatively thick layers of PLA: innermost layer 55, core layer 56, and outermost layer 57, and the two relatively thin layers of the active oxygen barrier composition: inner and outer intermediate layers 58, 59.

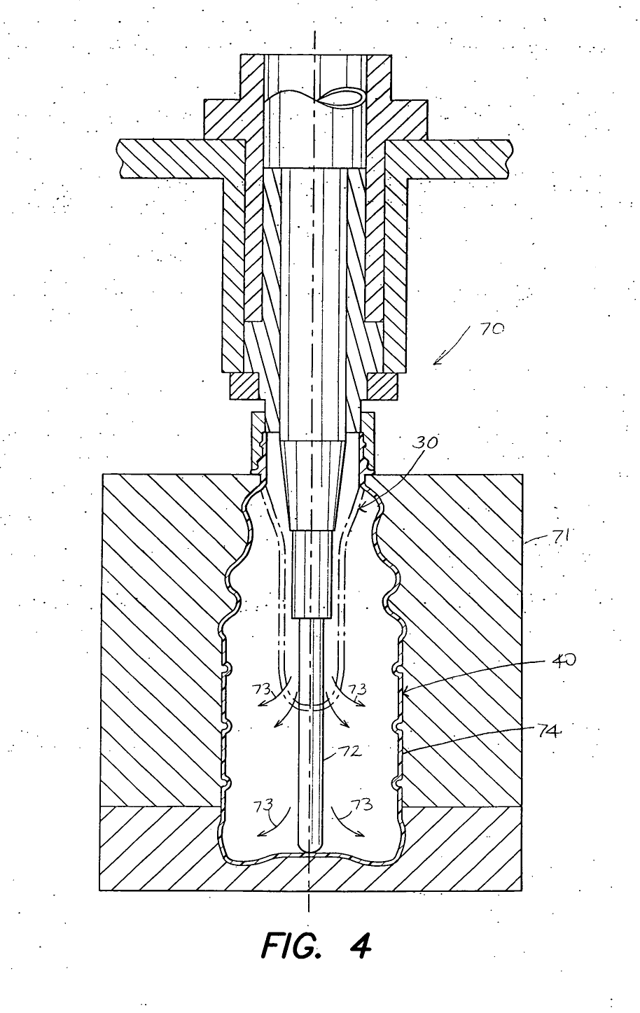

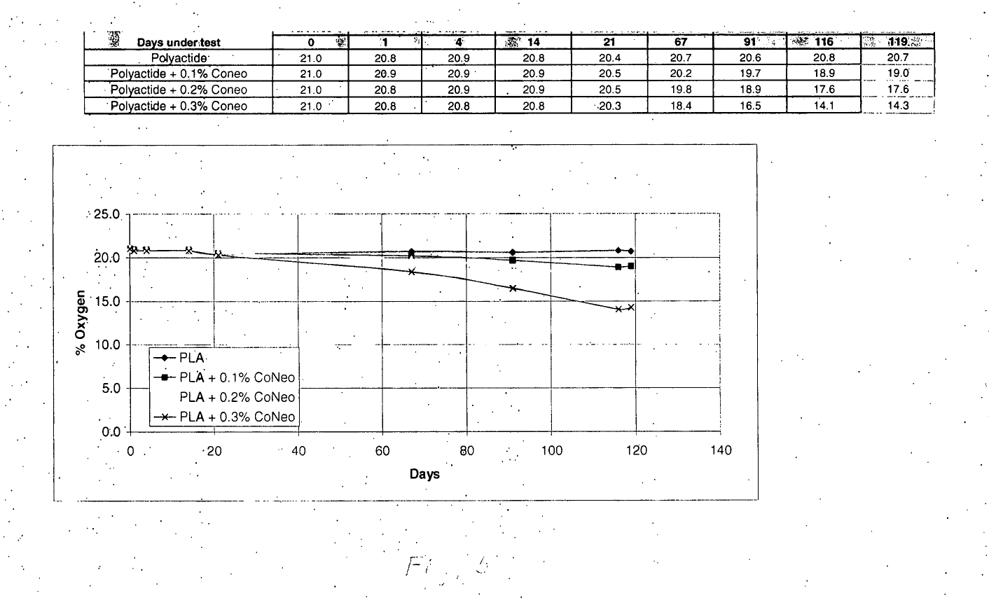

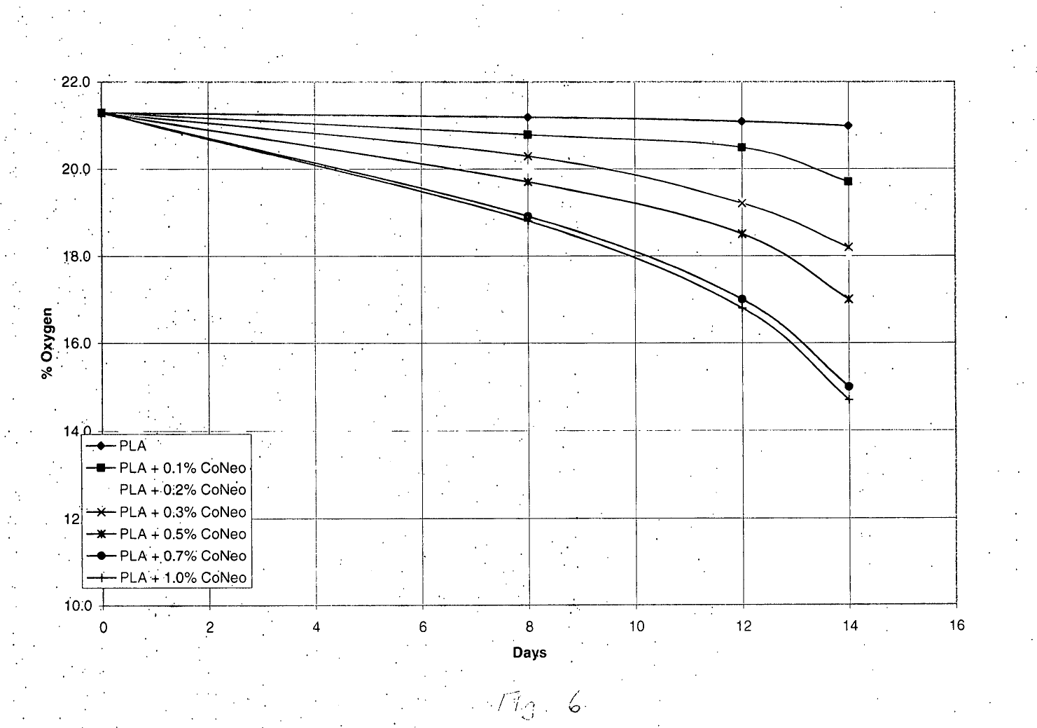

FIG. 4 illustrates a stretch blow molding apparatus 70 for making the container 40 from the preform 30. More specifically, the substantially amorphous and transparent preform body-forming section 38 is reheated to a temperature in the orientation temperature range of the innermost/outermost/core PLA layers, and the heated preform is then positioned in a blow mold 71. A stretch rod 72 axial elongates (stretches) the preform 30 within the blow mold to insure accurate centering and complete axial elongation of the preform. The blowing gas (shown by arrows 73) is introduced to radially inflate the preform to match the configuration of an inner molding surface 74 of the blow mold. The formed container 40 remains substantially transparent but has typically undergone strain-induced biaxial orientation to provide increased strength.

### EXAMPLE

### Preparation and Oxygen-Scavenging Performance of the Composition

The following example illustrates the effective inclusion of a transition metal in poly(lactic acid) to provide an active oxygen barrier composition according to one embodiment of the invention.

PLA resin was obtained from NatureWorks, Grade 7000D. Cobalt neodecanoate was obtained from Shephard Chemicals, 4900 Beech Street, Norwood, Ohio, USA.

The active barrier composition was prepared by grinding pastilles of the cobalt neodecanoate to a powder of less than 100 mesh. The powder was then tumble blended in a sealed container with an appropriate amount of PLA pellets. The polymer/cobalt blend was then input to an injection molding apparatus.

The amount of cobalt neodecanoate included in the above barrier composition was varied to determine the effect on oxygen scavenging. Plaque samples were prepared for each concentration (weight percentage of cobalt neodecanoate to composition) as shown below in Table 1.

An injection molded plaque was formed having dimensions of 6.25 inches (158.75 mm) in length by 1.75 inches (44.45 mm) in width, and having five equal sections with increasing step thicknesses of 0.04 inches (1 mm), 0.07 (1.78 mm), 0.10 inches (2.54 mm), 0.13 inches (3.3 mm), 0.16 inches (4.06 mm). Seven plaques were enclosed in a 32 ounce glass jar and one ounce of water added under ambient air (21% oxygen at 23° C.). The plaques rested on a platform above the water in the jar. The jar was capped with a standard canning jar lid, having a rubber septum. A syringe was inserted into the septum to withdraw a gas sample from the jar. The gas sample was then injected into a Mocon model PacCheck 450 Head Space Analyzer to measure the oxygen content (available from Mocon Modern Controls, 7500 Boone Avenue North, Minneapolis, Minn. 55428, USA). After measuring an initial oxygen content of about 21.0%, subsequent measurements were taken over a period of several days (e.g., 1 day, 4 days, 14 days . . . ). The results are shown in the following Table 1:

TABLE 1

| | Days under test | | | | | | | | |
|---|---|---|---|---|---|---|---|---|---|
| | 0 | 1 | 4 | 14 | 21 | 67 | 91 | 116 | 119 |
| PLA | 21.0 | 20.8 | 20.9 | 20.8 | 20.4 | 20.7 | 20.6 | 20.8 | 20.7 |
| PLA + 0.1% CoNeo | 21.0 | 20.9 | 20.9 | 20.9 | 20.5 | 20.2 | 19.7 | 18.9 | 19.0 |
| PLA + 0.2% CoNeo | 21.0 | 20.8 | 20.9 | 20.9 | 20.5 | 19.8 | 18.9 | 17.6 | 17.6 |
| PLA + 0.3% CoNeo | 21.0 | 20.8 | 20.8 | 20.8 | 20.3 | 18.4 | 16.5 | 14.1 | 14.3 |

As set forth in Table 1, all compositions which included cobalt neodecanoate (CoNeo) reduced the oxygen concentration in the jar to 20% or less, at least by 91 days. A higher rate of scavenging was achieved with increasing metal content.

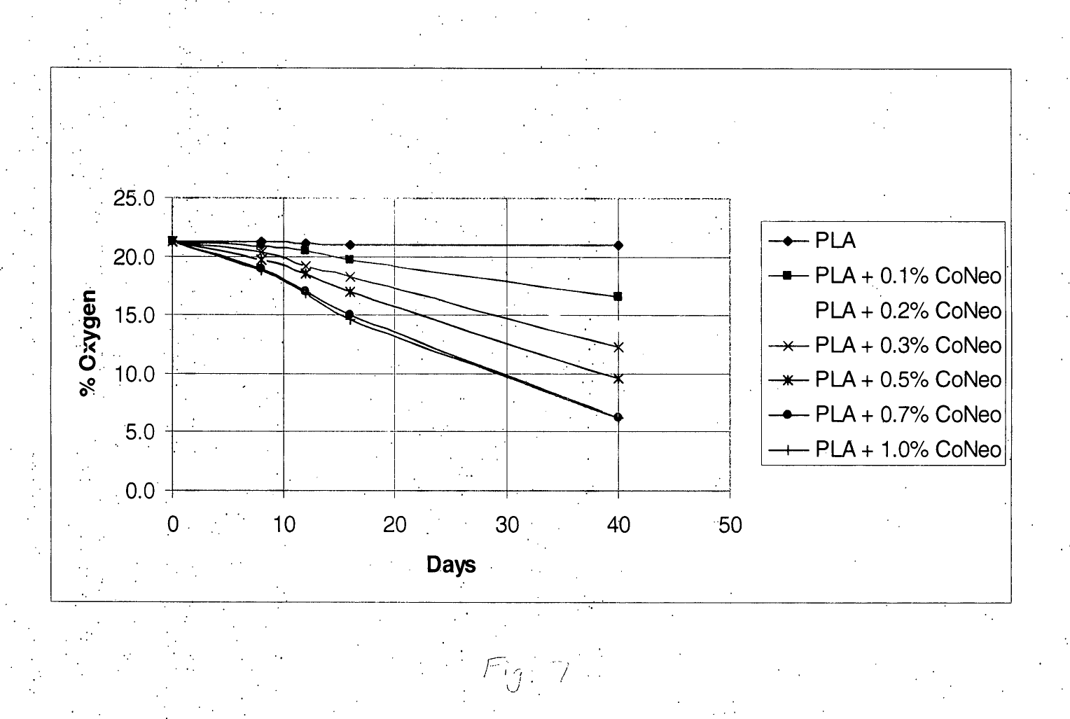

FIG. 5 is a graph of the data contained in Table 1. Starting with an initial oxygen level of 21%, the change in percent oxygen content from 0 to 119 days is illustrated for each of the 4 plaque types (PLA alone; PLA with 0.1% CoNeo; PLA with 0.2% CoNeo; PLA with 0.3% CoNeo). There was little change in oxygen content for the PLA without transition metal. The level of oxygen continued to decrease in each of the samples with transition metal present, the rate of decrease in oxygen concentration increasing with increasing transition metal content.

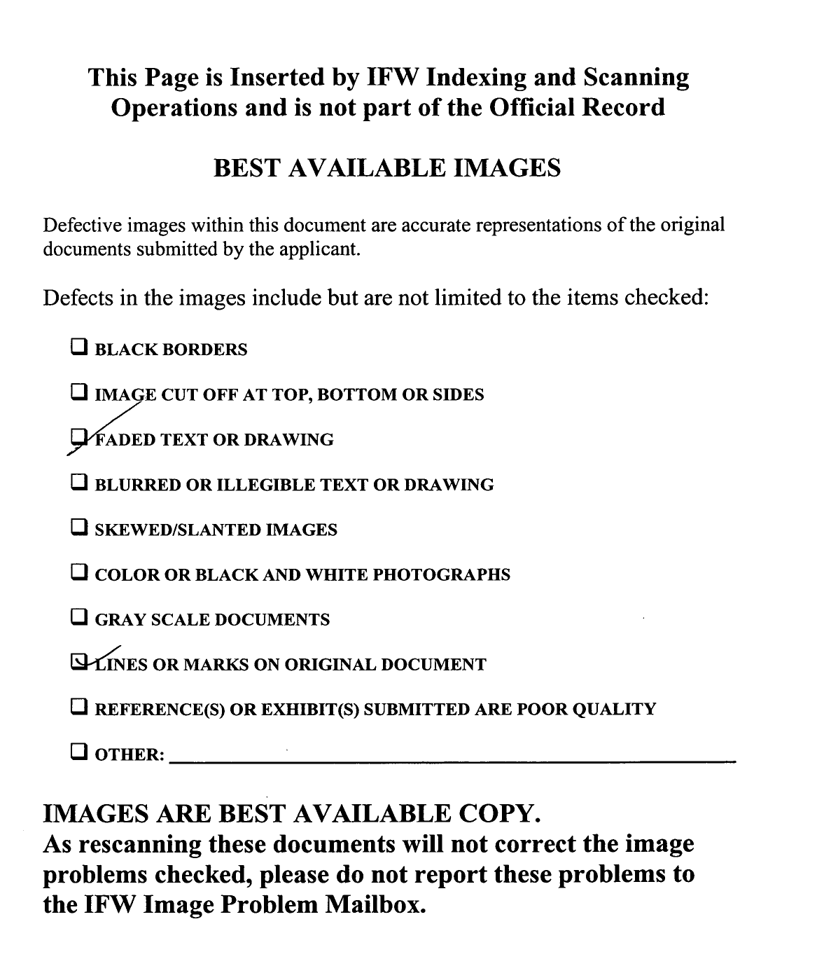

FIG. 6 is a similar graph comparing a wider range of transition metal content (from 0.1% to 1.0%), over an initial 14 day period. These plaque samples were stored at 100° F. (compared to room temperature for the plaque samples of FIG. 5), which increased the rate of oxygen reduction. Again, in each case where transition metal was present there was an increasing reduction in oxygen content over the 14 days, with the amount of reduction generally increasing along with the increasing transition metal content.

FIG. 7 is a similar graph showing the performance of the same plaques as in FIG. 6, but extended to 40 days. Again, the oxygen level content for all of the samples with transition metal continued to decrease over the 40 day period, the reduction increasing with increasing transition metal content.

As used herein, “oxygen scavenger” and the like means a composition, article or the like which consumes, depletes or reacts with oxygen from a given environment.

“Polymer” and the like herein means a homopolymer but also copolymers thereof, including random polymers, block polymers, graft copolymers, etc.

As used herein, an article of manufacture includes a rigid, semi-rigid or flexible article.

While there have been shown and described several embodiments of the present invention, it will be obvious to those skilled in the art that various changes and modifications may be made without departing from the scope of the invention as defined by the appending claims.

1. An active oxygen barrier composition comprising poly(lactic acid) and a transition metal.

2. The composition of claim 1, wherein the transition metal is present in an amount of at least about 20 ppm in the poly(lactic acid).

3. The composition of claim 1, wherein the transition metal is cobalt.

4. The composition of claim 3, wherein the transition metal is provided as a metal compound comprising cobalt neodecanoate.

5. The composition of claim 4, wherein the cobalt neodecanoate comprises from about 0.01 to about 3 percent by weight of the composition.

6. An article of manufacture made from the composition of claim 1, comprising at least a portion of a package, preform, container, film, sheet, liner, coating or closure.

7. The article of claim 6, wherein the article is a monolithic article.

8. The article of claim 6, wherein the article is a multilayer article.

9. The article of claim 8, wherein the multilayer article includes at least one layer of the composition and at least one layer of poly(lactic acid).

10. The article of claim 9, wherein the multilayer article includes innermost, core and outmost layers of poly(lactic acid), and two intermediate layers, between the innermost and outmost layers and on opposite sides of the core layer, of the composition.

11. The article of claim 9, wherein the multilayer article includes innermost and outermost layers of poly(lactic acid) on opposite side of a core layer of the composition.

12. The article of claim 9, wherein the multilayer article is a preform or container.

13. The article of claim 6, wherein the article is a package for an oxygen sensitive food or beverage.

14. An active oxygen barrier composition comprising:
a poly(hydroxyalkanoate) polymer of the formula H—[O—CHR—(CH₂)ₓ—CO]ₙ—OH and a transition metal, where R is hydrogen or an organic radical having up to about 13 carbon atoms, x is from 0 to 3, and n is from about 10 to about 20,000.

15. The composition of claim 14, wherein R is a hydrocarbon radical.

16. The composition of claim 14, wherein x is 0.

17. The composition of claim 14, where n is from 1 to 3.

18. The composition of claim 14, wherein the transition metal is present in an amount of at least about 20 ppm in the poly(hydroxyalkanoate) polymer.

19. The composition of claim 14, wherein the transition metal is cobalt.

20. The composition of claim 19, wherein the transition metal is provided as a metal compound comprising cobalt neodecanoate.

21. The composition of claim 20, wherein the cobalt neodecanoate comprises from about 0.01 to about 3 percent by weight of the composition.

22. An article of manufacture made from the composition of claim 14, comprising at least a portion of a package, preform, container, film, sheet, liner, coating or closure.

23. The article of claim 22, wherein the article is a monolithic article.

24. The article of claim 22, wherein the article is a multilayer article.

25. The article of claim 24, wherein the multilayer article includes at least one layer of the composition and at least one layer of poly(hydroxyalkanoate) polymer.

26. The article of claim 25, wherein the multilayer article includes innermost, core and outmost layers of poly(hydroxyalkanoate) polymer and two intermediate layers, between the innermost and outmost layers and on opposite sides of the core layer, of the composition.

27. The article of claim 24, wherein the multilayer article includes innermost and outermost layers of poly(hydroxyalkanoate) polymer layered on opposite sides of a core layer of the composition.

28. The article of claim 25, wherein the multilayer article is a preform or container.

29. The article of claim 22, wherein the article is a package for an oxygen-sensitive food or beverage.

30. A method of making a multilayer article for holding an oxygen sensitive product comprising:
molding an intermediate article having a first layer comprised of a poly(hydroxyalkanoate) polymer and a second layer adjacent the first layer comprised of a poly(hydroxyalkanoate) polymer and a transition metal, and
expanding the intermediate article to form the multilayer article.

31. A method of imparting oxygen scavenging activity to a packaging article that is comprised of multiple layers of poly(hydroxyalkanoate) polymer, the method comprising mixing a transition metal into at least one of the multiple layers of the article.

32. A method of imparting oxygen scavenging activity to a poly(hydroxyalkanoate) polymer composition comprising mixing a transition metal with a poly(hydroxyalkanoate) polymer.

33. The method of claim 32, wherein the transition metal is added in an amount of at least 20 ppm in the poly(hydroxyalkanoate).

34. The method of claim 33, wherein the transition metal is added as cobalt neodecanoate in an amount of about 0.01 to about 3% by weight of the composition.

35. The method of claim 34, wherein the method includes forming at least a portion of a package, preform, container, film, sheet, liner, coating or closure from the composition, and wherein the portion consists essentially of the composition.

36. The method of claim 32, wherein the poly(hydroxyalkanoate) polymer is poly(lactic) acid, the transition metal is added as cobalt neodecanoate in an amount from about 0.01 to about 3% by weight of the composition, and the method comprises forming a packaging article consisting essentially of the composition.
